(19) United States
(12) Patent Application Publication
(10) Pub. No.: US 2017/0347399 A1
(43) Pub. Date: Nov. 30, 2017

(54) HEATING DEVICE

(71) Applicant: E.G.O. Elektro-Geraetebau GmbH, Oberderdingen (DE)

(72) Inventors: Roland Muehlnikel, Bretten (DE); Wolfgang Thimm, Karlsruhe (DE); Volker Block, Bretten (DE); Holger Koebrich, Kraichtal-Gochsheim (DE); Manuel Schmieder, Oberderdingen (DE); Matthias Mandl, Bretten (DE); Michael Tafferner, Malsch (DE)

(21) Appl. No.: 15/601,285

(22) Filed: May 22, 2017

(30) Foreign Application Priority Data
May 24, 2016 (DE) 10 2016 209 012.7

(51) Int. Cl. H05B 3/14; H05B 3/16

(52) U.S. Cl. CPC H05B 3/146; H05B 3/16; H05B 2203/02

(57) ABSTRACT

A heating device including a support and at least one heating element group on the support has at least one heating element on the support and two connection contacts for the heating element group. The two connection contacts are electrically disconnected from one another and make electrical contact with the single heating element or all of the heating elements of the heating element group for connection to a current supply or as a power connection. An effective width of all of the heating elements within a common heating element group is greater than an effective length of the single heating element or all of the heating elements of this common heating element group between the two connection contacts.

### CROSS-REFERENCE TO RELATED APPLICATIONS

This application claims priority to German Application No. 10 2016 209 012.7, filed May 24, 2016, the contents of which are hereby incorporated herein in its entirety by reference.

### TECHNOLOGICAL FIELD

The invention relates to a heating device comprising a support and at least one heating element group on the support, wherein a heating element group of this kind has one heating element or a plurality of heating elements on the support.

### BACKGROUND

Various heating devices of this kind are known from the prior art, see US 2015/086325 A1 and DE 102012200398 A1 for example. In the document, the heating elements of a heating element group of this kind run one behind the other in series. One problem with heating devices of this kind is that local temperature increases, so-called hotspots, can occur. These can be the result of an insufficient amount of heat being drawn from a local area, for example when the heating device, by way of a side which is not covered by the heating elements, is adjacent to, even in the flow of, water which is to be heated, and limescale deposits are formed here.

### BRIEF SUMMARY

The invention is based on the problem of providing a heating device of the kind mentioned in the introductory part with which problems in the prior art can be solved and it is possible, in particular, to design a heating device in an expedient manner for safe and reliable operation which is preferably also secure against operating faults such as local temperature increases.

This problem is solved by a heating device. Advantageous and preferred refinements of the invention are the subject matter of the further claims and will be described in more detail below. The wording of the claims is included in the description by express reference.

It is provided that the heating device has a support and at least one heating element group on the support, that is to say one heating element group or a plurality of heating element groups. A heating element group in turn has at least one heating element which is mounted on the support, that is to say one heating element or a plurality of heating elements. A planar film-type heating element, in particular a thick-film heating element as is known from the prior art, is advantageous. Furthermore, each or the at least one heating element group has two connection contacts for the heating element group, advantageously precisely two connection contacts for each heating element group. These two connection contacts are electrically disconnected from one another and make electrical contact with the single heating element or all of the heating elements of the heating element group in order to establish a direct or indirect connection to a current supply or power supply. This means that, in an advantageous refinement of the invention, one heating element or a plurality of heating elements can be provided for each heating element group, the electrical connection of the heating element group or the current connection or power connection of the heating element group being performed by only precisely these two connection contacts. A heating element can therefore be defined in that it runs between two connection contacts. Other heating element groups or other heating elements may possibly also be connected to these connection contacts, but, in respect of a heating element group, only these two connection contacts serve for connection to the outside or to a current supply or power supply. Two heating element groups are preferably never connected in parallel with one another, but rather always only in series. Heating elements which are connected in parallel particularly preferably always form a common heating element group.

For reasons of consistent use of terms, a “heating element group” is also understood within the scope of the present invention to mean an arrangement which has only one single heating element but is not generally understood to be a group.

According to the invention, it is provided that an effective width of the single heating element or all of the heating elements within a common heating element group is at least equal to an effective length of this single heating element or all of these heating elements of this heating element group running between the two connection contacts. If only one single heating element is provided for the heating element group, it is provided according to the invention that this single heating element is wider than it is long or its effective width is at least equal or advantageously greater than its length between the two connection contacts. In this case, the width of the heating element also runs between the connection contacts, wherein the connection contacts can also be longer than the width of a single heating element or all of the heating elements of the heating element group. If a heating element group has a plurality of heating elements, these heating elements are connected in parallel with one another owing to their connection to these two individual connection contacts. The effective width of the heating elements is then the sum of the widths of all of the individual heating elements. Intermediate spaces which are provided between the heating elements of a heating element group are not included in this since they do not actually play any role in electrical terms owing to the relationship between length and width and owing to the parallel connection of the heating elements.

The advantage of a heating element of this kind or a group of heating elements of this kind is that, with the geometric situation according to the invention, a smaller hot point, which can have, for example, a surface area of between 0.1% and 5% of a heating element or all of the heating elements of a heating element group, does not have such a severe or harmful effect. In the prior art, there is a temperature increase at a hot point of this kind or at a hotspot of this kind, as a result of which, with a PTC behavior of a heating element and the temperature increase per se, limescale deposits for example increase even further when water is heated, as a result of which the temperature consequently in turn increases even further. However, the heating element current has to flow past this hot point and therefore, in the event of damage, the heating device may be damaged or even burn out. However, if a heating element or a heating element group is wider than it is long, in order to achieve a certain heated surface area, the current can flow past relatively small hot points or hotspots as it were laterally. As a result, this point then cools down since the current flow is considerably lower, and the problem is at least not exacerbated.

In an advantageous refinement of the invention, the effective width of the single heating element or all of the heating elements together within the heating element group is at least twice the effective length between the two connection contacts. It can particularly advantageously be three times to ten times the length. A loss of a few per cent or even below one per cent of this surface area or of the heating output is then only insignificant and causes hardly any interference.

In a refinement of the invention, the effective length of the single heating element or all of the heating elements of a single common heating element group can correspond to the distance between the two connection contacts in the region of the heating element or the heating elements. Therefore, while the effective width for a plurality of heating elements is added up from the total width of the region which is covered by the heating element material, this is not the case for the length. If the heating elements are of different lengths, an average value is used as the effective length. If all of the heating elements of a common heating element group are of equal length, which is a preferred refinement, the effective length corresponds to the length of a single heating element.

The two connection contacts of a common heating element group are preferably each longer than a minimum distance between them. This is the case at least for the region in which the connection contacts make contact with heating elements of the common heating element group. Furthermore, the connection contacts can further make electrical contact with further heating element groups. Finally, the connection contacts can also merge with conductor tracks in order to be connected to further heating element groups or to the abovementioned current supply or power supply.

In a refinement of the invention, the two connection contacts of a common heating element group run parallel to one another, specifically at least in accordance with a length which corresponds at least to the effective width of the single heating element or all of the heating elements of the common heating element group. Owing to the two connection contacts of a common heating element group running parallel in this way, a particularly simple refinement of a heating device according to the invention is possible since then, even if a plurality of heating elements are provided within this heating element group, the heating elements are all of the same length. The heating elements can also be of the same width, but this actually only plays a subordinate role since they are interconnected in parallel in any case. The film thickness or heating element thickness should be the same; this will be discussed further.

The two mentioned connection contacts of a common heating element group are advantageously a power connection for the heating element group. Further electrical contacts to a heating element group or to a heating element can be provided, for example for measuring certain electrical variables. However, these are then designed only as a signal connection and therefore designed for considerably lower current flows. Furthermore, they do not influence the electrical properties, in particular the resistance and heating properties, of a heating element. These two connection contacts are advantageously also the only power connections of a common heating element group.

In a further refinement of the invention, electrical contact is made between the connection contacts and the at least one heating element by the heating element overlapping the connection contacts or the top side or surface of the connection contacts. Therefore, in a production method for the heating device, a connection contact is mounted first and only then the heating element with an at least partial overlap. However, this is known in principle from the prior art and has proven effective.

In principle, it is possible that a heating device has only one single heating element group. A plurality of heating element groups are advantageously arranged on the support, for example in order to achieve a larger surface area or better surface-area coverage. Therefore, by way of example, two to five heating element groups can be arranged on the support. These heating element groups are then particularly advantageously of identical design or each have the same number of heating elements and/or have heating elements of the same size. As a result, a layout of the heating device can be created more easily. In addition, heat generation which is as uniform as possible can be achieved by the heating device in this way.

In an advantageous refinement of the invention, a surface-area heating output of the heating device at each point which is covered by the heating element material or a heating element is substantially the same or identical everywhere. Therefore, a current density should also be the same everywhere, at least during normal operation of an undamaged heating device or without hotspots.

In an advantageous refinement of the invention, it can be provided that all of the heating element groups and/or all of the heating elements are identical to one another or are of the same size. In particular, rectangular heating elements are advantageously provided.

In a simple refinement of the invention, the at least one heating element group, particularly advantageously all of the heating element groups of a heating device, advantageously has only one single heating element between its two connection contacts. Maximum surface-area coverage is achieved in this way.

In a further refinement of the invention, it can advantageously be provided that the at least one heating element has a constant thickness between the two connection contacts of its associated heating element group. Therefore, production, in particular by thick-film methods or thin-film methods which are known per se, is simplified. All of the heating elements of the heating device particularly advantageously have the same thickness of this kind between their respective connection contacts. Therefore, all of the heating elements of a heating device can be produced using a common or several common identical application methods, this in turn simplifying production. In addition, an abovementioned identical current density or surface-area heating output can preferably be achieved in this way.

A heating element can advantageously be designed as a thin-film heating element or as a thick-film heating element. A border between these two types is approximately 10 μm to 20 μm of the film thickness. The advantage of a refinement as a thick-film heating element is that this technology has proven effective for planar heating devices and is controllable.

In a refinement of the invention, the at least one heating element, in particular all of the heating elements of a common heating element group or even the entire heating device, can have a positive temperature coefficient of the electrical resistance. Particularly advantageously, the same heating element material is always used. A positive temperature coefficient of this kind can have the effect that, in the case of a small or locally very limited hotspot or a hot region, the electrical resistance there increases and a current flow runs around this region or runs past this region in order to prevent further overheating and possible damage to the heating device.

The heating element can be composed of any material which is usually used and also from a carbon-based material. In an advantageous refinement of the invention, the at least one heating element is composed of a heating element material which is not carbon-based or does not contain any carbon, at least not any electrically conductive carbon. The heating element material can advantageously contain a precious metal, such as silver for example. The heating element material can particularly advantageously contain silver and palladium, for example in the form of so-called conductive silver paste.

These and further features can be gathered not only from the claims but also from the description and the drawings, where the individual features can be realized in each case by themselves or severally in the form of subcombinations in an embodiment of the invention and in other fields and can constitute advantageous and inherently protectable embodiments for which protection is claimed here. The subdivision of the application into subheadings and individual sections does not restrict the general validity of the statements made thereunder.

### BRIEF DESCRIPTION OF THE SEVERAL VIEWS OF THE DRAWINGS

Exemplary embodiments of the invention are schematically illustrated in the drawings and will be explained in greater detail below. In the drawings:

FIG. 1 shows a plan view of a heating device according to the invention comprising two rectangular heating elements on it;

FIG. 2 shows an alternative heating device comprising an approximately square support and eight heating elements on it, the heating elements being interconnected in parallel in pairs in each case;

FIG. 3 shows a side view of a tubular heating device, in which a plurality of strip-like heating elements run on the outside of a tubular support from bottom to top in two heating element groups; and

FIG. 4 shows a modification to the heating device from FIG. 1 with a single very wide heating element.

### DETAILED DESCRIPTION

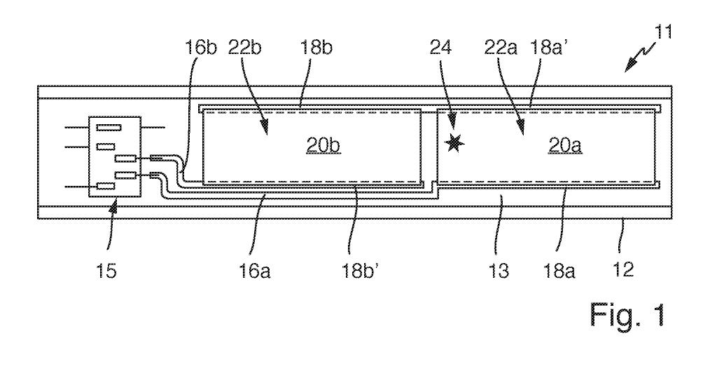

FIG. 1 shows a heating device 11 with a flat and elongate rectangular support 12. This support 12 could also be imagined as a developed projection of a short tube with a round cross section, so that the left-hand-side end and the right-hand-side end would be closed and the inner side of the tube would be formed from the bottom side of the support 12. A planar insulating layer 13 is applied to the support 12. This corresponds to a usual construction.

A connection device 15 in the form of a plug or the like is mounted on the left-hand-side on the support 12. Supply lines 16a and 16b which open into connection contacts 18 extend from this connection device 15. The supply line 16a leads, at the bottom right, to a lower connection contact 18a. An upper connection contact 18a′ is situated opposite the lower connection contact, wherein this upper connection contact 18a′ merges directly with a further upper connection contact 18b. For all intents and purposes, the upper connection contacts form a common connection contact. A connection contact 18b′ is situated opposite the upper connection contact 18b at the bottom, the bottom connection contact then merging with the supply line 16b, and this then leading to the connection device 15.

Two heating elements 20a and 20b are provided on the insulating layer 13, the heating elements being mounted on the connection contacts 18 in an overlapping manner, as is known for film-type heating elements or thick-film heating elements. The lateral distance between the heating elements is very small and amounts to a few mm. The two heating elements 20a and 20b have the same size surface area and are substantially also the same or identical in terms of design. As shown, the width of the heating elements is between three and four times their length, that is to say they are very short and very wide. The two heating elements 20a and 20b each form a separate heating element group 22a and 22b. Therefore, there are two heating element groups 22a and 22b even though each has only one single heating element 20, and they are interconnected in series. If the heating elements 20a and 20b were connected in parallel, there would be only one single heating element group comprising two heating elements.

The heating elements 20a and 20b are formed from a preferred heating element material which advantageously contains a precious metal, particularly advantageously silver and possibly also additionally palladium. The heating element material advantageously has PTC properties. Very generally, a heating element material which is free of carbon or is not carbon-based, that is to say does not contain any carbon at least in the finished ready-to-operate state, is particularly advantageous. Heating element materials of this kind are known from the prior art and are used primarily for thick-film heating elements, as are provided here. Possible application methods for the heating element material are those known from the prior art.

In the exemplary embodiment of a heating device 11 illustrated in FIG. 1, a constant or uniform thickness of the heating elements 20 is provided. This thickness can be, for example, 20 μm to 70 μm, that is to say still in a thick-film range. The surface area can be just below 40 cm², so that a power of approximately 2000 W is generated given a voltage of 230 V on the supply lines 16. This means a sheet resistance of 63 Ω/□ and a load per unit area of somewhat above 50 W/cm².

FIG. 1 shows a so-called hotspot 24 with an extent of approximately 5 mm by 5 mm. The hotspot is located in the left-hand-side region of the right-hand-side heating element 20a. However, as is clearly shown, it can be assumed, in the region of the hotspot 24 and on account of the PTC properties of the heating elements 20a and 20b, that the electrical resistance in the heating element 20a rises in this region on account of the temperature increase produced at the hotspot 24. For this reason, a current flow will become lower here, this current flow moving into the relatively wide regions to the left-hand side and of course primarily to the right-hand side of the hotspot. Therefore, less thermal energy is then in turn generated in this region of the hotspot 24. As a result, a further temperature rise can be delayed or prevented and the hotspot 24 does not cause severe interference and, respectively, the heating device 11 cannot be damaged.

Owing to extensive temperature monitoring which is known from the prior art in the form of US 2014/029928 A1 and DE 102013200277 A1, this hotspot 24 may be found and an indication can be output to an operator that limescale removal should be performed when the heating device 11 is used in a boiling water appliance or steam generator. As an alternative, the voltage may possibly also be monitored by monitoring the current flowing through the heating element 20a and the voltage applied to the connection contacts 18a′ and 18a, possibly by means of an auxiliary contact on the connection contact 18a′. A change in these values can likewise be assessed as the occurrence of a hotspot.

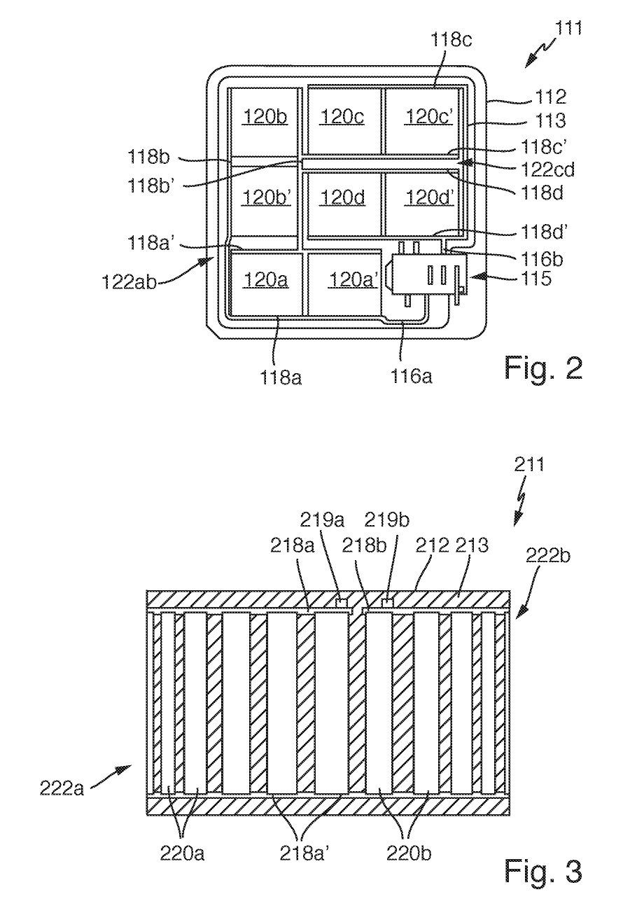

FIG. 2 shows a further heating device 111 which likewise has a flat and planar support 112 which is substantially square here but otherwise has the same construction as that from FIG. 1 in many respects. An insulating layer 113 is applied to the support 112 together with a connection device 115 with supply lines 116a and 116b. The supply line 116a runs to connection contacts 118a and 118b. Two parallel heating elements 120a and 120a′ and also 120b and 120b′ are respectively provided on the connection contacts. At the other end, the heating elements are in turn connected to connection contacts 118a′ and 118b′ which merge.

The supply line 116b runs to connection contacts 118d′ and 118c. Two parallel heating elements 120d and 120d′ and also 120c and 120c′ are respectively provided on the connection contacts. At the other end, the heating elements are in turn connected to connection contacts 118d and 118c′. These connection contacts 118d and 118c′ are in turn connected to one another and to the connection contacts 118a′ and 118b′.

All of the heating elements 120 are of identical design and are substantially square. The pairs of heating elements 120, which pairs are respectively connected in parallel and situated directly next to one another, could also cover the thin gaps which separate them, and therefore form a single heating element. Two pairs of heating elements 120 in each case form a heating element group 122a and 122b, that is to say a total of two heating element groups. This configuration produces a series circuit of two groups of four heating elements, wherein the heating elements of each group of four are inherently connected in parallel. This is shown by the course of the connection contacts 118. The heating elements 120 can correspond to those of FIG. 1 in respect of material and in respect of application method too. In a similar form, the support 112 could also be a developed projection of a bent or even of a tubular support. A tubular support would then have a considerably greater length than width.

FIG. 3 shows a side view of a further heating device 211 which has a tubular support 212 in the form of a short round-cylindrical tube. Connection contacts 218a and 218b are provided in the upper region on the outside of the tube or on an insulating layer 213, the connection contacts being separated from one another or not meeting either at the front or at the rear side. A connection contact 218a′ runs as it were continuously or largely continuously at the bottom. The lower connection contact 218a′ can also have a gap at the rear side, but it can also be continuous or circumferential.

The connection contact 218a is connected to a connection contact area 219a which is in the form of a convexity of the connection contact 218a. Similarly, a connection contact area 219b extends from the connection contact 218b. An electrical contact-making means, such as a line or the like for example, can be mounted on the connection contact areas 219a and 219b, advantageously by soldering or welding.

A plurality of strip-like heating elements 220a and 220b of the same width run between the connection contacts 218a and, respectively, 218b on the top side and the lower connection contact 218a′. Therefore, this means that approximately ten heating elements 220a and, respectively, 220b in each case form a heating element group here, and these two heating element groups 222a and 222b are then connected in series. The situation according to the invention applies to each heating element group 222a and, respectively, 222b which are advantageously of identical design. The individual heating elements 220a and 220b themselves are elongate with a length which is a multiple of the width. However the effective length of the heating elements of a heating element group is lower than their summed width, so that an effective width of all of the heating elements together within a heating element group is greater than the effective length thereof for each heating element group here too.

Since there are a relatively large number of heating elements within a common heating element group in FIG. 3, it is also easy to imagine that, for example, two of the strip-like heating elements 220a or 220b are always combined to form a single heating element. They would then therefore form a strip which is somewhat more than double the width.

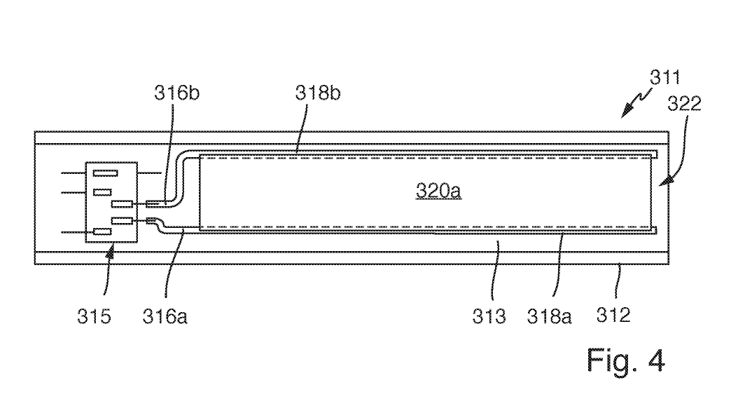

FIG. 4 shows a yet further heating device 311 as a modification to that from FIG. 1. In comparison to FIG. 1, the course of the supply lines 316a and 316b is somewhat different on an identical support 312 with an insulating layer 313 and an identical connection device 315. The reason for this is that not only is the connection contact 318b continuous, as it already was in FIG. 1, but a lower continuous connection contact 318a is also provided. A single heating element 320a runs between these two connection contacts, the heating element being wider than it is long, once again by a factor of 2, in comparison to that from FIG. 1. In particular, it is approximately seven times as wide as it is long. Similarly to in FIG. 1, a hotspot would cause only little interference here.

There is therefore a situation in which only a single heating element group 322 comprising only one single heating element 320 is provided in the heating device 311. As has already been explained in the introductory part, the term “heating element group” is also used here even when only one single heating element is contained in the heating element group.

Comparison with the heating device 11 from FIG. 1 shows that the heating element 320 could also have a narrow gap, which runs over its length, in the center. There would then be two separate heating elements, but since these would be connected in parallel, their effective width would be only slightly reduced, specifically only by the amount of the width of the exposed strip. In addition, there would then further be only one single and common heating element group since the two heating elements are connected to the same connection contacts.

That which is claimed:

1. A heating device comprising:
a support; and
at least one heating element group on said support;
wherein said heating element group comprises:
at least one heating element on said support; and
two connection contacts for said heating element group, wherein said two connection contacts are electrically disconnected from one another and make electrical contact with said single heating element or with all of said heating elements of said heating element group for connection to a power supply,
wherein an effective width of said single heating element or all of said heating elements together within one said common heating element group is at least equal to an effective length of said single heating element or to an effective length of all of said heating elements of said common heating element group between said two connection contacts.

2. The heating device according to claim 1, wherein:
said effective width of said single heating element or all of said heating elements together within said heating element group is at least twice said effective length between said two connection contacts.

3. The heating device according to claim 2, wherein:
said effective width of said single heating element or all of said heating elements together within said heating element group is three times to ten times said effective length between said two connection contacts.

4. The heating device according to claim 1, wherein:
said effective length corresponds to a distance between said two connection contacts in a region of said single heating element or of all of said heating elements of said heating element group.

5. The heating device according to claim 1, wherein:
said two connection contacts are each longer than a minimum distance between them.

6. The heating device according to claim 1, wherein:
said two connection contacts run parallel to one another over a length which corresponds at least to an effective width of said single heating element or all of said heating elements within said associated heating element group.

7. The heating device according to claim 1, wherein:
said two connection contacts within said associated heating element group are power connections.

8. The heating device according to claim 7, wherein:
said two connection contacts within said associated heating element group are the only power connections of said heating element group.

9. The heating device according to claim 1, wherein:
two to five said heating element groups are arranged on said support.

10. The heating device according to claim 9, wherein:
said heating element groups have in each case the same number of said heating elements or said heating elements are of the same size.

11. The heating device according to claim 1, wherein:
said heating element groups or said heating elements are identical to one another.

12. The heating device according to claim 1, wherein:
said at least one heating element group comprises only one single heating element between its two connection contacts.

13. The heating device according to claim 1, wherein:
said at least one heating element comprises a constant thickness between said two connection contacts of its associated heating element group.

14. The heating device according to claim 13, wherein:
all of said heating elements of said heating device comprise the same thickness between their respective connection contacts.

15. The heating device according to claim 1, wherein:
said at least one heating element is applied to said support as a thin film or as a thick film.

16. The heating device according to claim 1, wherein:
said at least one heating element comprises a positive temperature coefficient of its electrical resistance.

17. The heating device according to claim 16, wherein:
all of said heating elements comprise a positive temperature coefficient of its electrical resistance.

18. The heating device according to claim 1, wherein:
said heating element material comprises a positive temperature coefficient of its electrical resistance.

19. The heating device according to claim 1, wherein:
said at least one heating element is composed of a heating element material which is not carbon-based.

20. The heating device according to claim 19, wherein:
said at least one heating element comprises silver.

21. The heating device according to claim 20, wherein:
said at least one heating element comprises silver and palladium.
